(19) United States
(12) Patent Application Publication
(10) Pub. No.: US 2011/0208563 A1
(43) Pub. Date: Aug. 25, 2011

(54) Pricing, Marketing and Inventory Control System Based on Demand

(76) Inventor: Kyle Bengt Barnas, Fayetteville, NC (US)

(21) Appl. No.: 13/030,691

(22) Filed: Feb. 18, 2011

Related U.S. Application Data
(60) Provisional application No. 61/306,646, filed on Feb. 22, 2010.

(51) Int. Cl. G06Q 30/00

(52) U.S. Cl. 705/7.35

(57) ABSTRACT

A pricing, marketing and inventory control system and method provide a unique scenario for selling consumer products. For an inventory of consumer goods, baseline prices are established. Additionally, price increase indicators are defined, and a price increment for each of the consumer goods is defined. Similarly, price decrease indicators are defined, and a price decrement for each of the consumer goods is defined. Current prices of the consumer goods are displayed, and the current prices are adjusted by the price increment upon occurrence of one of the price increase indicators and by the price decrement upon occurrence of one of the price decrease indicators. The process is repeated as sales are made.

### CROSS-REFERENCES TO RELATED APPLICATIONS

This application claims the benefit of U.S. Provisional Patent Application Ser. No. 61/306,646, filed Feb. 22, 2010, the entire content of which is herein incorporated by reference.

### STATEMENT REGARDING FEDERALLY SPONSORED RESEARCH OR DEVELOPMENT

(Not Applicable)

### BACKGROUND AND SUMMARY OF THE INVENTION

The invention relates to a pricing, marketing and inventory control mechanism that allows patrons the opportunity to participate in and manipulate the pricing of a product by virtue of what exactly they purchase, in what quantity they make the purchase and the timing of the purchase.

The method encapsulates the basic laws of economics and provides instantaneous price changes sensitive to both supply and demand. In a free market, the equilibrium price of a good is that at which the quantity supplied equals the quantity demanded. The method tailors the price of a good to increase or decrease instantaneously per x transactions dependent upon the state of demand. When the demand for a product increases, the price will increase. When demand is scarce or nonexistent, the price will decrease to advertise/stimulate a sale or discount.

The method operates on these elementary business laws and instantaneously responds accordingly. It can be applied to both retail and wholesale transactions.

In an exemplary embodiment of the invention, a pricing, marketing and inventory control method is provided for consumer goods in a retail establishment. The method includes the steps of (a) establishing baseline prices for an inventory of consumer goods; (b) defining price increase indicators and a price increment for each of the consumer goods; (c) defining price decrease indicators and a price decrement for each of the consumer goods; (d) displaying current prices of the consumer goods; (e) adjusting the current prices by the price increment upon occurrence of one of the price increase indicators; (f) adjusting the current prices by the price decrement upon occurrence of one of the price decrease indicators; and (g) repeating from step (d).

Step (d) may be practiced by displaying an upwardly pointing arrow for consumer products with an increasing price and displaying a downwardly pointing arrow for consumer products with a decreasing price. Moreover, the price increment for a specific consumer good may be determined based on anticipated demand for the specific consumer good. In one arrangement, the method includes monitoring a rate of sales of a particular consumer good at various price points.

The price increase indicators may comprise a rate of sale of the consumer goods. The price increase indicators may alternatively comprise a number of the consumer goods sold. The price decrease indicators may comprise an elapsed time period between sales of the consumer goods.

In another exemplary embodiment, a pricing, marketing and inventory control system for consumer goods in a retail establishment includes a system server storing baseline prices for an inventory of consumer goods. The system server includes a price increase module storing price increase indicators and a price increment for each of the consumer goods and a price decrease module storing price decrease indicators and a price decrement for each of the consumer goods. A display communicates with the system server and displays current prices of the consumer goods. A processor communicates with the system server and adjusts the current prices by the price increment upon occurrence of one of the price increase indicators and adjusts the current prices by the price decrement upon occurrence of one of the price decrease indicators.

The display may generate a moving ticker display of the current prices of the consumer goods.

The system may additionally include a client computer communicating with the system server, where the client computer includes user interface structure enabling user input relating to the consumer goods. In this context, the client computer is programmed to accept an order for the consumer goods.

### BRIEF DESCRIPTION OF THE DRAWINGS

These and other aspects and advantages will be described in the following detailed description with reference to the accompanying drawings, in which:

FIG. 1 is schematic block diagram showing the system and method of the preferred embodiments; and

FIG. 2 shows a pricing model for a consumer product.

### DETAILED DESCRIPTION OF THE INVENTION

Demand for a product can be said to be very inelastic if consumers will pay almost any price for the product, while demand for a product may be elastic if consumers will only pay a certain price, or a narrow range of prices, for the product. Inelastic demand means a producer can raise prices without much hurting demand for its product, and elastic demand means that consumers are sensitive to the price at which a product is sold and will not buy it if the price rises by what they consider too much. Drinking water is a good example of a good that has inelastic characteristics—in that under certain circumstances and in the absence of competitive suppliers, people will pay anything for it. On the other hand, demand for soda is very elastic because as the price of any given brand or flavor increases there are many substitute goods to which consumers may switch.

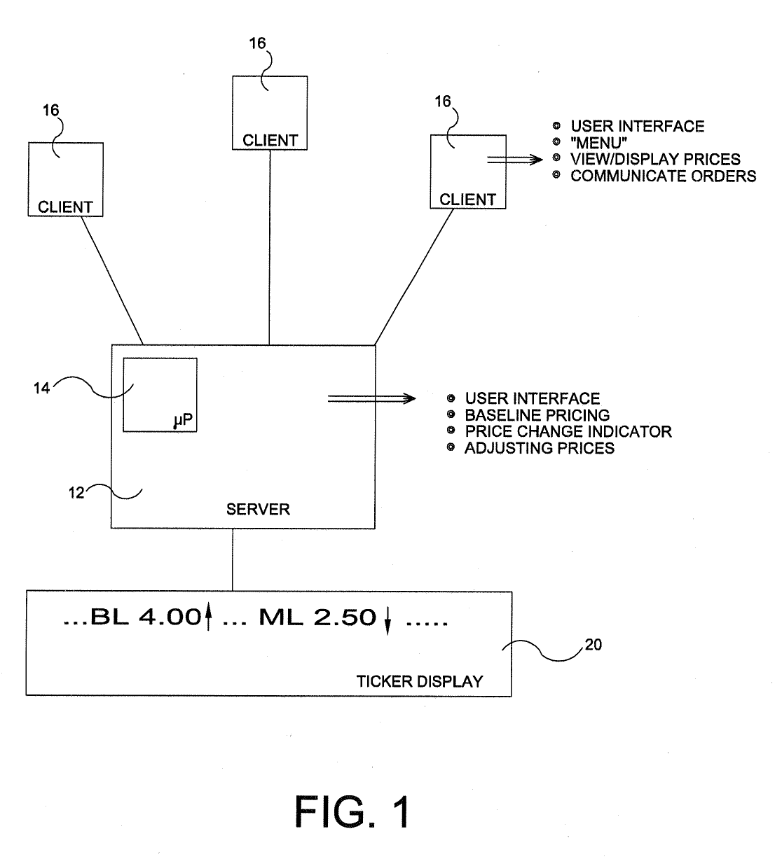

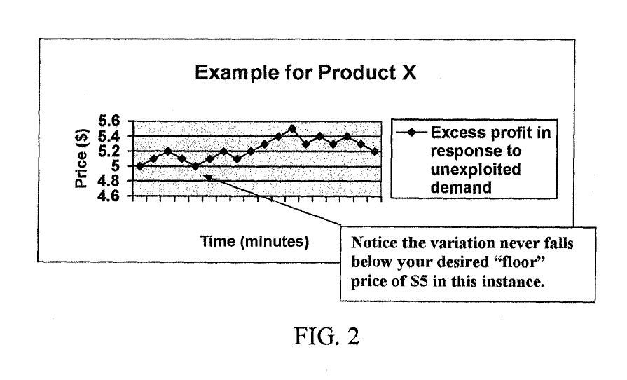

In a “bar” application, the system for carrying out the method may include a continuously streaming ticker strip resembling that of a securities exchange that would run at locations within the establishment and be visible to all of the patrons. With reference to FIG. 1, the ticker strip 20 is driven by a server 12 including a microprocessor 14 and other known components used for operating and interacting with a computer system (e.g., user interface, memory, programming, etc.). Additionally, the ticker strip display 20 itself can be of any known structure, and the structural details thereof will not be described. On the strip would be abbreviations for many of the items on the menu (most likely various drinks), which would electronically and automatically (based upon programming choices made by the bar operator) change in price depending on what the customer purchases, in what quantity they make the purchase, and the timing of the purchase (price increase/decrease indicators). The ticker strip may indicate whether the price of a particular item is rising with an arrow, for example a green arrow, or falling with an arrow, for example a red arrow (see FIG. 2). If, for example, Bud Light® is a popular drink on a given night (price increase indicator), the price will continue to rise until demand has diminished (x amount of time, e.g., 10-15 minutes, has passed between purchases—price decrease indicators), at which point the price will begin to decline back to a level that will serve to increase demand. In the meantime, customers would have the opportunity to seek bargain pricing on less popular items or venture to try a new drink, perhaps identified as an “Initial Public Offering.”

A “split” can also be programmed to occur. A range of prices can be predetermined for a given product by the bar operator. A “stock split” can be simulated by the price of, for example, Bud Light® rising from the starting price of $2.00 per unit to $4.00 per unit then “splitting (2 for 1)” to the price of $2.00 per unit again. In the alternative, if the price reaches a height of $3.90 for example and no customer is willing to make the next purchase for $3.90 or above because they anticipate a split at $4.00, MTBP (mean time between purchases—price decrease indicator) becomes an important price manipulating factor bringing the prices down incrementally over time when there are a lack of purchases for a particular product. Therefore, if the price on a good is high and no one is willing to buy, in time (predetermined by the operator), the price will fall until purchases commence again.

Applied to a bar on the holidays, an operator would be able to anticipate demand of various drinks and set price steps accordingly. Instead of the price of Champagne increasing $0.05 per unit sold on New Year's Eve, the steps could be set to $0.10, $0.20 or whatever the operator believes would be the optimal value given the elasticity or lack thereof on any given occasion. Over a predetermined time if demand diminishes for one brand or particular product (price decrease indicator), the price would begin to come down by a predetermined amount to attract more demand as stated before. This gives the operator the flexibility to manage his inventory of specialty products (which have less of a sales history) by changing the price at any given time to increase or decrease sales and subsequently manage inventory.

Another example is Cinco de Mayo. When the operator anticipates high sales of Mexican beer and margaritas on this Mexican holiday, more profitable price increments can be set because the price on these items would most likely be more inelastic. This method would assist business owners in capitalizing on various special occasions, weekends and holidays. It would also provide data about the rate of sales at particular price points, allowing the operator to better understand what customers are willing to pay for specific items and what inventory to maintain.

The method creates constant, active control and more profitability for business owners as well as incentives for the consumer. The business owner has complete control of incremental price increases and decreases as well as the time that must elapse before price adjustments. The method gives more power to the operator and decreases the time, personnel, and paperwork it would take to adjust to variations in demand.

The owner has the ability to change any product's price instantaneously through the system, which would be reflected on the streaming ticker strip of various products for sale. The method creates convenience and enhances profit potential for the business owner.

The consumer has a motivation to purchase more of a given product before others due to the anticipation of price increases. While the business owner has complete control, the consumer will anticipate various price fluctuations and prepare accordingly by potentially purchasing numerous drinks in advance, purchasing “futures.” A futures contract is a standardized contract to buy or sell a specified commodity of standardized quality at a certain date in the future and at a market-determined price, i.e., the futures price. In this method for example, a customer could pre-purchase 10 Bud Light® beers for a fixed price (whatever the current market price happens to be at the time of purchase). A customer (or group of customers at a table) would be motivated to pre-purchase product x if they believed it would rise in price later in the day/evening (with limitations placed upon the purchase such as one drink at a time per person at the table so that one customer doesn't place a large futures order and begin to broker drinks throughout the bar at a price above their purchase price).

The method also creates competition and motivates customers to come earlier than their “competitors” (other consumers competing for the same low prices). By the same token, customers who arrive later in the evening would benefit from price reductions on drinks that are less popular on that particular day and benefit from stock splits on popular items. The method would create a competitive marketplace in any business application, which is extremely beneficial for a business owner.

Consider the situation where someone believes that they ordered a drink at the $2.00 price quoted by the ticker strip, but by the time the waitress gets to place the order, the price has gone up. In operating the system, every order should be confirmed at the time that it is placed. In one embodiment, with continued reference to FIG. 1, the system includes a plurality of client computers 16, which may be user terminals at restaurant tables, bar seats, etc. At a particular bar, for instance, the client computers 16 may be hand-held devices allowing the waitresses to place orders at prices that are reflected on the ticker strip and produce a paper confirmation of the trade. As an alternative and to make the experience more interactive for the customers, the client computers 16 may include a touch screen device placed at each table. As a customer finds a menu item that they want to order, they could enter the abbreviation on the touch screen at which time the price would appear next to it (which is the same price being displayed on the ticker strip 20). The customer would input the number of units that they want to purchase for that item and either hit “place order” or wait for the price to reach a number that they find attractive. In either case, as soon as they hit “place order,” the order is printed at a separate station, and a “floor trader” comes to their table to confirm the trade (or deliver the requested product). As an alternative, the touch screen could confirm the order and require the customer to acknowledge confirmation before the order is placed. Once the trade is confirmed, it is transmitted to a waitress station or handed to a waitress who fills the order just as in a normal restaurant or bar. At the end of the evening, the multiple order confirmations can be compared against the final bill to confirm the total. The touch screen system could be enhanced to allow customers to place limit/buy orders and purchase “futures” as discussed previously.

Another alternative would require connecting the bar's website to the ticker strip and order confirmation system. For instance, if a customer in the bar already has a web browser on their phone, they could go to the bar's website and order their drinks at the ticker strip prices at which time the floor trader would get a printed order and proceed to their table to confirm the trade. It would also be strategic marketing for businesses to utilize this method by placing their “tickers” online so customers can compare and anticipate the specials or “undervalued securities” in “real time.”

After confirmation of the trade, a waiter/waitress places the order and serves the customers as is customary. They will need to be able to explain the ordering system and ticker strip to new patrons, but it will not be complicated. Regarding gratuity, at the operator's discretion a “brokerage fee” could be programmed into each trade to represent the tip. Otherwise, patrons could compute and leave tips at their discretion.

In a “bar” application, the method would allow the business owner to start at any given time in a state of equilibrium with fixed inputs of supply. Assume a bar has 100x, 100y and 100z drinks to supply in a given evening The bar owner has the power to set price, quantity and time increments for price adjustments both upwards and down. If drinks x and y are more popular in a given time frame than drink z, the prices of drinks x and y would increase thereby testing the elasticity of their demand. Realistically, the prices would eventually reach a level where they become less desirable. Drink z then, which would have fallen in price incrementally by a predetermined amount, would become more desirable at that specific time, until a point at which the same laws of economics occur. If drink z becomes popular, its price would escalate while the prices of drinks x and y would fall until they become more demanded. The law of demand applies to the substitution of cheaper goods for more expensive goods due to a relative change in price. If drink z fails to pick up in demand over a specified timeframe for whatever reason, the operator can trigger a split or crash in either or both drinks x or y to stimulate sales.

Depending on the particular location, an approaching customer may see a streaming ticker strip outside for advertising purposes, as well as a ticker strip on the inside so that he or she can react to the streaming information. This “ticker strip” can be any monitor or device that makes public the price fluctuations occurring. This would mimic a securities exchange as described but will be completely different in subject matter and application. Upon entering a bar or restaurant, for instance, an unfamiliar customer could place their order with a waitress or participate electronically by using the touch screen or web browser as described previously. At the end of the evening, the customer would be presented with a final bill, which could be compared to the individual order confirmations for accuracy. Payment would then occur normally as it does in existing restaurants and bars.

The operator has the ability to start the ticker strip with any set of pricing he chooses. One could close the market where it left off and reopen the following day with the same prices, or adjust the pricing based upon information gained from the previous days' sales, or simply reset to a standard default before every opening

The method does not require the bartenders or waitresses to have an advanced education in finance. The system includes software programming to connect the ticker strip to the touch screen monitors at the tables and to the cash registers so that the purchase of a given item would produce a trade confirmation and influence the ticker strip pricing based upon previously programmed parameters set by the operator (i.e., the sale of 10 units causes an increase in price of $0.10 per unit). As previously mentioned, it may also require connecting the bar's website to the ticker strip and ordering system. The price reflected on the ticker strip would depend on the speed of sales, the quantity of sales, and the particular product sold. After the order is placed and confirmed, a waitress or bartender would handle the order as it is customarily done.

The operator has complete control over their product's pricing. As a novelty, and to keep the experience exciting, the operator would be able to simulate a “market crash” or “recession” by depressing the prices of particular goods, or of every good being sold at any time to “stimulate” the market. The range of possibilities and scenarios is limited only to the imagination of the operator. There could be a “gold rush” where gold tequila goes on discount, and its depressed price would be reflected on the ticker tape until a second scenario occurs.

The method is horizontal in nature; that is, applicable across many industries. In regards to cost, it is up to the means of the operator to implement the method how he/she chooses. One could merely use the idea as a happy hour special or turn on the ticker strip at certain hours of operation. One could have a combination of fixed price items (i.e. tea and coffee) and trading items. One could separate the inventory by class (merlot, cabernet, whiskey, vodka, imported and non imported beer etc.) and have streaming prices that affect the entire class. One could merely have the price variations at the bar (in the “trading pit”) while offering fixed priced drink menus to those sitting at tables who choose not to participate in the “market” trading. Ultimately, an operator could either fit this method into their original business model, or they could build a new business model around this method.

Price setters are those companies that dictate the price its customers pay for goods and services. Price takers are those companies that cannot dictate their prices because their prices are dependent on the market. The method takes benefits from both options and utilizes them in a way that creates competition in the “marketplace” (the individual business in question), while maintaining complete control. With the method and system of the invention, a business is able to not only dictate the price its customers pay for their goods and services by setting a “floor” or minimum price (the starting equilibrium price which should already have costs and a profit built in), but will also “allow” themselves higher margins by giving their patrons full responsibility over driving prices up or down dependent upon their preferences. See FIG. 2.

With the proper application of this method, patrons will find excitement and novelty in their ability to cause price fluctuations and seek deals. The dynamic environment will also encourage social interaction. The operator will benefit from an inventory control system, a marketing tool and a pricing mechanism that allows him or her to make instantaneous adjustments to maximize revenues or induce the purchase of new or less popular products. Over time, the continuous accumulation of sales data for each item at various price points will allow for strategic planning and a more accurate forecasting of future operations.

While the invention has been described in connection with what is presently considered to be the most practical and preferred embodiments, it is to be understood that the invention is not to be limited to the disclosed embodiments, but on the contrary, is intended to cover various modifications and equivalent arrangements included within the spirit and scope of the appended claims.

1. A pricing, marketing and inventory control method for consumer goods in a retail establishment, the method comprising:
(a) establishing baseline prices for an inventory of consumer goods;
(b) defining price increase indicators and a price increment for each of the consumer goods;
(c) defining price decrease indicators and a price decrement for each of the consumer goods;
(d) displaying current prices of the consumer goods;
(e) adjusting the current prices by the price increment upon occurrence of one of the price increase indicators;
(f) adjusting the current prices by the price decrement upon occurrence of one of the price decrease indicators; and
(g) repeating from step (d).

2. A method according to claim 1, wherein step (d) is practiced by displaying an upwardly pointing arrow for consumer products with an increasing price and displaying a downwardly pointing arrow for consumer products with a decreasing price.

3. A method according to claim 1, wherein the price increment for a specific consumer good is determined based on anticipated demand for the specific consumer good.

4. A method according to claim 1, further comprising monitoring a rate of sales of a particular consumer good at various price points.

5. A method according to claim 1, wherein the price increase indicators comprise a rate of sale of the consumer goods.

6. A method according to claim 1, wherein the price increase indicators comprise a number of the consumer goods sold.

7. A method according to claim 1, wherein the price decrease indicators comprise an elapsed time period between sales of the consumer goods.

8. A pricing, marketing and inventory control system for consumer goods in a retail establishment, the system comprising:
a system server storing baseline prices for an inventory of consumer goods, the system server including a price increase module storing price increase indicators and a price increment for each of the consumer goods and a price decrease module storing price decrease indicators and a price decrement for each of the consumer goods;
a display communicating with the system server, the display displaying current prices of the consumer goods; and
a processor communicating with the system server, the processor adjusting the current prices by the price increment upon occurrence of one of the price increase indicators and adjusting the current prices by the price decrement upon occurrence of one of the price decrease indicators.

9. A system according to claim 8, wherein the display generates a moving ticker display of the current prices of the consumer goods.

10. A system according to claim 8, further comprising a client computer communicating with the system server, the client computer including user interface structure enabling user input relating to the consumer goods.

11. A system according to claim 10, wherein the client computer is programmed to accept an order for the consumer goods.

12. A system according to claim 8, wherein the price increment for a specific consumer good is determined based on anticipated demand for the specific consumer good.

13. A system according to claim 8, wherein the processor is programmed to monitor a rate of sales of a particular consumer good at various price points.

14. A system according to claim 8, wherein the price increase indicators comprise a rate of sale of the consumer goods.

15. A system according to claim 8, wherein the price increase indicators comprise a number of the consumer goods sold.

16. A system according to claim 8, wherein the price decrease indicators comprise an elapsed time period between sales of the consumer goods.
